(19) United States
(12) Patent Application Publication
(10) Pub. No.: US 2017/0252714 A1
(43) Pub. Date: Sep. 7, 2017

(54) GAS INFUSION SYSTEMS FOR LIQUIDS AND METHODS OF USING THE SAME

(71) Applicants: Tyler Bennett, Lemoore, CA (US); Ofer Rosenfeld, Hanford, CA (US)

(72) Inventors: Tyler Bennett, Lemoore, CA (US); Ofer Rosenfeld, Hanford, CA (US)

(21) Appl. No.: 15/448,579

(22) Filed: Mar. 2, 2017

Related U.S. Application Data
(60) Provisional application No. 62/302,381, filed on Mar. 2, 2016.

(51) Int. Cl. B01F 13/10; B01F 3/04; A01G 25/16; B01F 11/02; E02B 11/00; A01G 25/06; B01F 5/04; B01F 5/16

(52) U.S. Cl. CPC B01F 13/1027; B01F 5/0415; B01F 3/0446; B01F 3/04978; B01F 3/04106; B01F 5/16; B01F 5/162; B01F 11/0208; B01F 11/0283; E02B 11/005; A01G 25/06; A01G 25/16; B01F 2003/04872

(57) ABSTRACT

The present invention provides subsurface irrigation systems and air injection mechanism and microbubble generating mechanism. The systems of the present invention are operable to provide an evenly distributed air microbubbles in a stream of fluid (e.g., subsurface irrigation water) to evenly provide gas therein (e.g., oxygen for plants receiving the irrigation water along an entire length of an irrigation line). The microbubble generating mechanism may use pressure generated from flow of fluid to cavitate the fluid and thereby distribute gas microbubbles in the fluid. In irrigation examples, the resulting air infused water delivers an effective amount of oxygen to the roots of the irrigation crops.

### FIELD OF THE INVENTION

The present invention relates to mechanisms for infusing liquids with gases, irrigation systems that include such mechanisms, and methods of using the same. More particularly, the present invention relates to microbubble generating mechanisms and there use in irrigation systems and methods of using the same.

### DISCUSSION OF THE BACKGROUND

Conventional growing procedures for plants and crops include watering by applying water to the soil surface. The applied water includes some dissolved oxygen in it that is carried to the roots by virtue of the water filtering into the soil. The amount of oxygen provided roots by surface watering is not optimal and can be insufficient depending on soil composition. To compensate for the oxygen inefficiencies of surface water, the ground may be permitted to dry in order to admit air into the soil, which may be dissolved and carried to the roots by the next irrigation or watering. This is a tedious and imprecise technique, rife with inefficiencies. For example, it is difficult for a farmer to gauge the amount of time needed to properly oxygenate the soil and the ideal volume and frequency of water applications. Too much water can literally drown the crop (due to too little oxygen). Too little water results in crop wilt and failure, or at least reduction in quality and production. Additionally, due to ongoing drought conditions in many agricultural regions, water waste is increasingly objectionable and expensive as water supplies have diminished due to drought.

The infusion of irrigation water with additional air and oxygen can be a means for improving over conventional irrigation techniques. Watering cycles may revamped and improved if sufficient oxygen and nitrogen can be delivered to the root systems of plants through water supplies themselves. However, air bubbles present in a water column have buoyancy that is proportional to the volume of air contained therein. Thus, to improve on conventional techniques, schemes are required for reducing the size of air bubbles in irrigation water or otherwise increasing the solubility and retention of air bubbles in the irrigation water.

Previous systems have been developed for subterranean delivery of irrigation water to the roots systems of plants, with the aim of reducing the amount of water required and increased the amount of air or other nourishing gases to the soil surrounding the root systems. However, there are still drawbacks to such systems, including a lack of uniformity in the size of the generated air bubbles and larger than ideal air bubble sizes limit the efficiency and effectiveness of previously developed systems. For example, larger air bubbles (e.g., air bubbles having an average diameter of greater than about 10 μm) tend to rise and surface in the column of irrigation water in a relatively short period. Thus, air bubbles of that size may not reach the distal end of an irrigation line (e.g., irrigation tape or tube) of an extensive length (e.g., tens to hundreds of yards) in sufficiently concentration.

Improvements in technologies for infusing water and other liquids with air are needed for the agricultural industry and in other industrial and technological fields.

### SUMMARY OF THE INVENTION

The present invention provides cavitating apparatuses for generating microbubbles in a liquid, liquid distribution (e.g., irrigation) systems using the same, and methods of using the same. The cavitating apparatuses distribute bubbles having a diameter in the range of about 80 nm to about 10 μm (“microbubbles”) in a stream of water or other liquid supplied through a liquid distribution system. Such distribution systems may be, e.g., subterranean irrigation systems in which distributed air bubbles may deliver oxygen to the roots where it is needed for nourishment and development of the plants served by the irrigation system. Air delivery is particularly usual for plants that are grown in dense soils, which do not admit much atmospheric oxygen and can become relatively anoxic.

The cavitating apparatuses of the present invention may include a gas (e.g., air) delivery system that connects to a liquid delivery system and draws gas from an outside source (e.g., a gas reservoir, the atmosphere, etc.), a gas injector (e.g., a Venturi tube) that connects the gas delivery system to the liquid delivery system, and an inline cavitating turbine within a liquid conduit for creating microbubbles within the liquid. The cavitating turbine may be positioned inline within the liquid conduit downstream of the gas delivery system, which may supply gas into the liquid from the atmosphere, a gas reservoir, or other source. In some embodiments, and without limitation, the gas delivery system may draw air from the atmosphere, for example, through a filter for removing particulates. Gas drawn into the liquid through the gas delivery system need not be pressurized, and is drawn into the liquid through a gas injection port by pressure dynamics. For example, the gas injector may be a Venturi tube that chokes the diameter of the liquid conduit to reduce pressure and draw gas into the liquid through the gas injection port. Other mechanisms may be used to introduce or draw gas into the liquid through the gas injector. In other examples, and without limitation, the gas may be provided from a pressurized source (e.g., a pressurized tank, pump, etc.) to push the gas into the liquid. The introduction of the gas into the liquid in the conduit provides gas to be supplied downstream (e.g., to plant root systems). The cavitating turbine then utilizes the gas introduced by the gas delivery system to generate microbubbles.

The turbine may be freely rotating, and have various designs, such as a gas turbine blade design, Francis turbine blade design, a Kaplan turbine blade design, etc. The cavitating turbine may create microbubbles by multiple mechanisms. First, the shearing forces created by the spinning blades of the cavitating turbine may breakup gas bubbles present in the water as a result of gas injection by the gas injector to create smaller gas bubbles. Second, the cavitating turbine may create new microbubbles by dropping the static pressure of the liquid passing through the conduit to a point that dissolved gases degas to form microbubbles. The rotation of the blades of the cavitating turbine may be driven by the dynamic pressure (the flow) of the liquid passing through the cavitating turbine without any additional driving force applied to the turbine. The size, shape, and number of the turbine blades may have a relationship to the size of the microbubbles created by the turbine at a given dynamic pressure and flow volume. The size, shape, and number of turbine blades can be varied depending on the particular application (e.g., conduit size, dynamic fluid pressure, liquid composition, etc.). In some embodiments, the cavitating apparatus of the present invention may include a plurality of cavitating turbines therein (e.g., the cavitating system may include 3, 4, or more inline cavitating turbines). The plurality of cavitating turbines may be configured such that at least one spins in a clockwise direction and at least one of the plurality of cavitating turbine spins in the opposite direction. It is to be further understood that the fluid delivery system (e.g., subterranean irrigation system) into which the gas-liquid mixture feeds may also include cavitating turbines placed at intervals therein. These additional cavitating turbines may aid in keeping the gas dissolved and suspended in the water column.

Once the liquid stream has passed through the cavitating turbine it may be delivered to its target location(s) through a considerable length of conduit without losing a significant proportion of the microbubbles distributed therein. In some embodiments, and without limitation, the cavitating system may be part of an irrigation system (e.g., a subterranean irrigation system) and the gas-infused liquid may be passed through a subsurface conduit, such as a drip irrigation tape or tube buried in the ground (e.g., to a depth in a range of about 4 inches to about 24 inches). Irrigation conduit typically extends for many tens to hundreds of yards, often along rows of crops such as strawberries and peppers. The gas-infused irrigation water is discharged along the length of the conduit through perforations or gaps in the conduit. In order for the gas bubbles in the irrigation water to persist to the end of the conduit so that plant roots located at the end of the irrigation conduit receive adequate oxygen and/or other gases, the gas bubbles need to remain dissolved in the water column.

The microbubbles of gas generated by the cavitating system of the present invention are carried as a suspension in a flowing stream. In order for the gas bubbles to stay distributed in solution for a sufficient period of time, they preferably have a diameter within a particular range (about 80 nm to about 1 μm). Microbubbles in that size range may stay distributed in solution, resisting coalescence and degassing. This may be due to balancing between charge force generated at the gas-liquid interface of the microbubble and the surface tension of the liquid. Curved aqueous surfaces may introduce a surface charge due to water's molecular structure, and like charges at the liquid-gas interface will reduce the internal pressure and the surface tension of the liquid as the charge repulsion at the surface of the bubble acts in the opposite direction to the surface tension. These two opposing forces may be at or near an equilibrium in the above-mentioned size-range, and thus coalescence may be resisted. Additionally, buoyancy may be negligible in such microbubbles preventing loss at the top of the liquid column. Thus, the cavitating turbine of the present invention may overcome the tendency of the gas to be released from the liquid or to coalesce, as occurs in conventional systems.

Therefore, the present invention provides an improved cavitating apparatus for generating microbubbles in liquids that can be used in various applications. In some embodiments, and without limitation, the present invention provides a cavitating system that can be utilized in various irrigation systems (e.g., subterranean irrigation systems) for infusing irrigation water or other liquids with gas bubbles (e.g., atmospheric air) that persist in liquid for substantially longer periods than provided by previous systems. Additionally, the present invention provides irrigation systems that include such cavitating systems and that are capable of delivering irrigation water or solution long distances (e.g., in a range up to 1000 yards) through conduit, while still delivering sufficient oxygen and/or other nourishing gases. The present invention also provides improved methods of gas delivery to root systems of plants utilizing a cavitating apparatus as described herein.

In some embodiments, and without limitation, the present invention relates to a cavitating apparatus, including a liquid delivery conduit for receiving liquid; a gas-liquid mixing chamber connected to a distal end of the liquid delivery conduit, wherein the gas-liquid mixing chamber includes a gas injection port; a gas delivery system connected to the gas injection port; a liquid exit conduit for collecting a liquid-gas mixture from a distal end of the gas-liquid mixing chamber; and an inline cavitating turbine in the liquid-gas mixture. The cavitating turbine may be operable to generate microbubbles having a diameter in a range of about 80 nm to about 10 μm. The cavitating turbine may be free-spinning, such that the pressure of the liquid-gas mixture drives the rotation of the cavitating turbine.

In another embodiment, and without limitation, the present invention relates to an irrigation system, including a main water delivery conduit for supplying water to an irrigation plot; a cavitating system including a siphoning conduit for drawing a portion of the water from the main water delivery conduit, a gas-liquid mixing chamber connected to a distal end of the siphoning conduit, wherein the gas-liquid mixing chamber includes a gas injection port, a gas delivery system connected to the gas injection port, a cavitated water delivery conduit for collecting a water-gas mixture from a distal end of the gas-liquid mixing chamber and delivering cavitated water back to the main water delivery conduit, and an inline cavitating turbine in the cavitated water delivery conduit for cavitating the water-gas mixture; and a plurality of irrigation lines for receiving water from the main water delivery conduit downstream from the cavitated water delivery conduit. The cavitating turbine may be operable to generate microbubbles having a diameter in a range of about 80 nm to about 10 μm. The cavitating turbine may be free-spinning, such that the pressure of the water-gas mixture drives the rotation of the cavitating turbine.

In another embodiment, and without limitation, the present invention relates to a method of creating a cavitated liquid comprising, including drawing a liquid from a liquid source into a proximal conduit; passing the liquid through a gas-liquid mixing chamber to generate a liquid-gas mixture, wherein the gas-liquid mixing chamber includes a gas injection port connected to a gas delivery system; collecting the liquid-gas mixture in a distal conduit; and passing the liquid-mixture through a cavitating turbine located within the lumen of the distal conduit. The cavitating turbine may be operable to generate microbubbles having a diameter in a range of about 80 nm to about 10 μm. The cavitating turbine may be free-spinning, such that the pressure of the gas-liquid mixture drives the rotation of the cavitating turbine.

In some embodiments, and without limitation, the present invention relates to a cavitating apparatus, including a liquid delivery conduit for receiving liquid; a Venturi tube connected to a distal end of the liquid delivery conduit, wherein the Venturi tube includes a gas injection port; an air delivery system connected to the gas injection port; a liquid exit conduit for collecting a liquid-gas mixture from a distal end of the Venturi tube; and an inline cavitating turbine in the liquid-gas mixture. The cavitating turbine may be operable to generate microbubbles having a diameter in a range of about 80 nm to about 10 μm. The cavitating turbine may be free-spinning, such that the pressure of the liquid-gas mixture drives the rotation of the cavitating turbine.

In another embodiment, and without limitation, the present invention relates to an irrigation system, including a main water delivery conduit for supplying water to an irrigation plot; a cavitating system including a siphoning conduit for drawing a portion of the water from the main water delivery conduit, a Venturi tube connected to a distal end of the siphoning conduit, wherein the Venturi tube includes a gas injection port, an air delivery system connected to the gas injection port, a cavitated water delivery conduit for collecting a water-air mixture from a distal end of the Venturi tube and delivering cavitated water back to the main water delivery conduit, and an inline cavitating turbine in the cavitated water delivery conduit for cavitating the water-air mixture; and a plurality of irrigation lines for receiving water from the main water delivery conduit downstream from the cavitated water delivery conduit. The cavitating turbine may be operable to generate microbubbles having a diameter in a range of about 80 nm to about 10 μm. The cavitating turbine may be free-spinning, such that the pressure of the water-air mixture drives the rotation of the cavitating turbine.

In another embodiment, and without limitation, the present invention relates to a method of creating a cavitated liquid comprising, including drawing a liquid from a liquid source into a proximal conduit; passing the liquid through a Venturi tube to generate a liquid-gas mixture, wherein the Venturi tube includes a gas injection port connected to a gas delivery system; collecting the liquid-gas mixture in a distal conduit; and passing the liquid-mixture through a cavitating turbine located within the lumen of the distal conduit. The cavitating turbine may be operable to generate microbubbles having a diameter in a range of about 80 nm to about 10 μm. The cavitating turbine may be free-spinning, such that the pressure of the water-air mixture drives the rotation of the cavitating turbine.

It is an object of the present invention to provide a system operable to consistent generate gas microbubbles in a liquid having a diameter in a range of about 80 nm to about 10 μm.

It is a further object of the present invention to provide a cavitating system for use in irrigation that is operable to infuse an irrigation liquid with oxygen and/or other gases that stay in solution for significantly longer than achieved by conventional systems.

It is an object of this invention to improve irrigation systems by providing uniform delivery of oxygen and/or other gases over the entire length of the irrigation conduit.

It is an object of the present invention to provide systems capable of producing significant increases in crop yield and quality, and accelerating the development of crops.

Additional aspects and objects of the invention will be apparent from the detailed descriptions and the claims herein.

### BRIEF DESCRIPTION OF THE DRAWINGS

FIG. 1 shows a cavitating apparatus according to an embodiment of the present invention.

FIG. 2A shows an exemplary cavitating turbine.

FIG. 2B shows an exemplary cavitating turbine.

FIG. 3 shows a cavitating apparatus according to an embodiment of the present invention.

FIG. 4 shows a cavitating apparatus according to an embodiment of the present invention.

FIG. 5 shows an exploded side view of a cavitating apparatus according to an exemplary embodiment of the present invention. Some of the individual parts of the embodiment are labeled for clarity. It should be noted that the size and specifications of the individual parts of the embodiment are simply for illustrative purposes and are not limitations on the scope of the present invention.

FIG. 6 shows a side view of the exemplary cavitating apparatus of FIG. 5 in an assembled condition.

FIG. 7 shows a cavitating apparatus according to an embodiment of the present invention.

FIG. 8 shows an overhead view of an exemplary irrigation system including an exemplary cavitating apparatus according to an embodiment of the present invention.

FIG. 9 shows an overhead view of an exemplary irrigation system including an exemplary cavitating apparatus according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

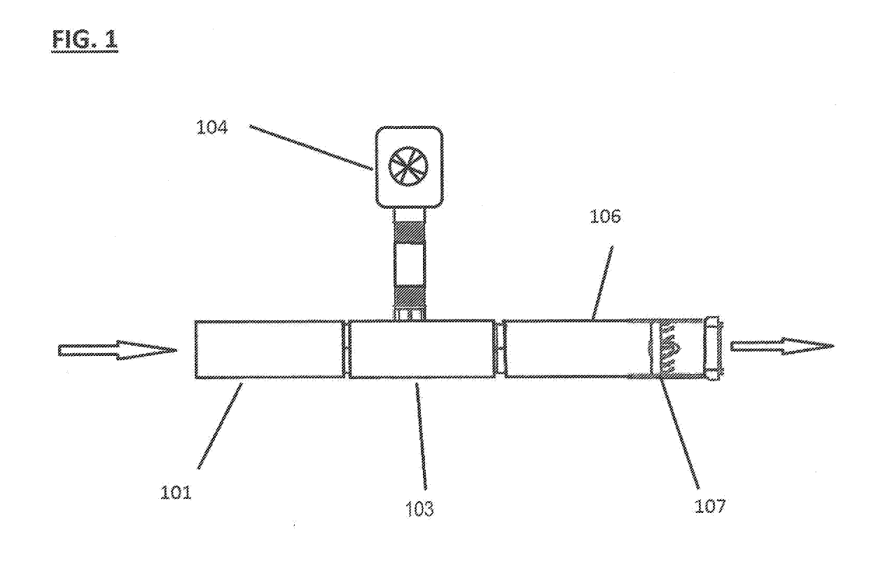

Referring to the drawings wherein like reference characters designate like or corresponding parts throughout the several views, and referring particularly to FIGS. 1-7, it is seen that the present invention includes various embodiments of cavitating apparatuses, systems using the same, and methods of using the same.

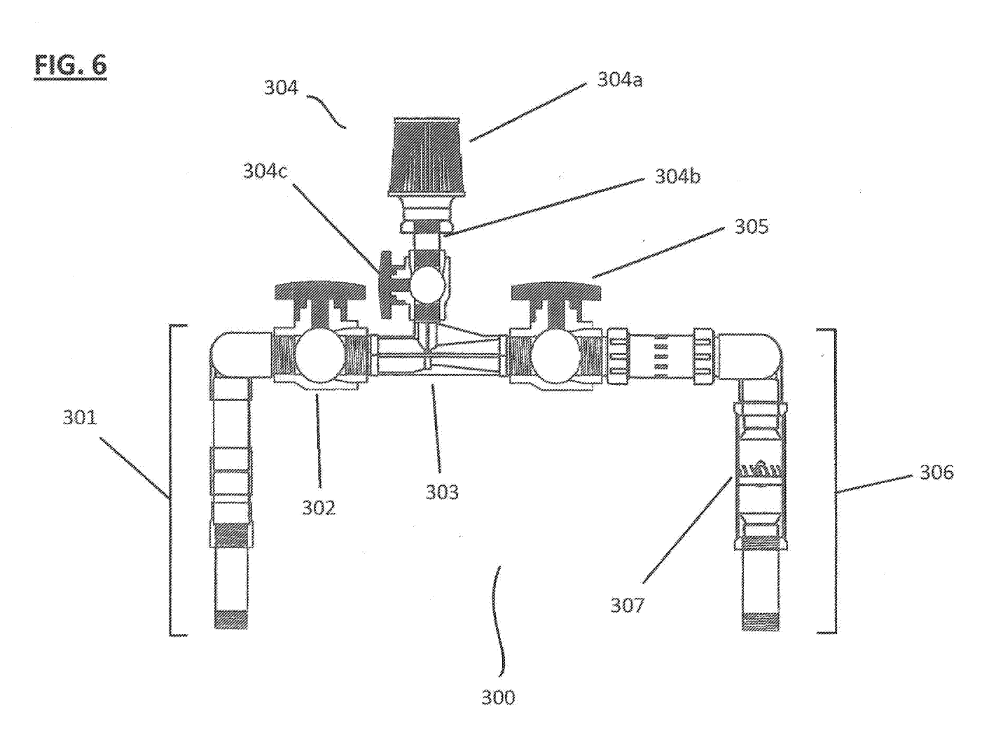

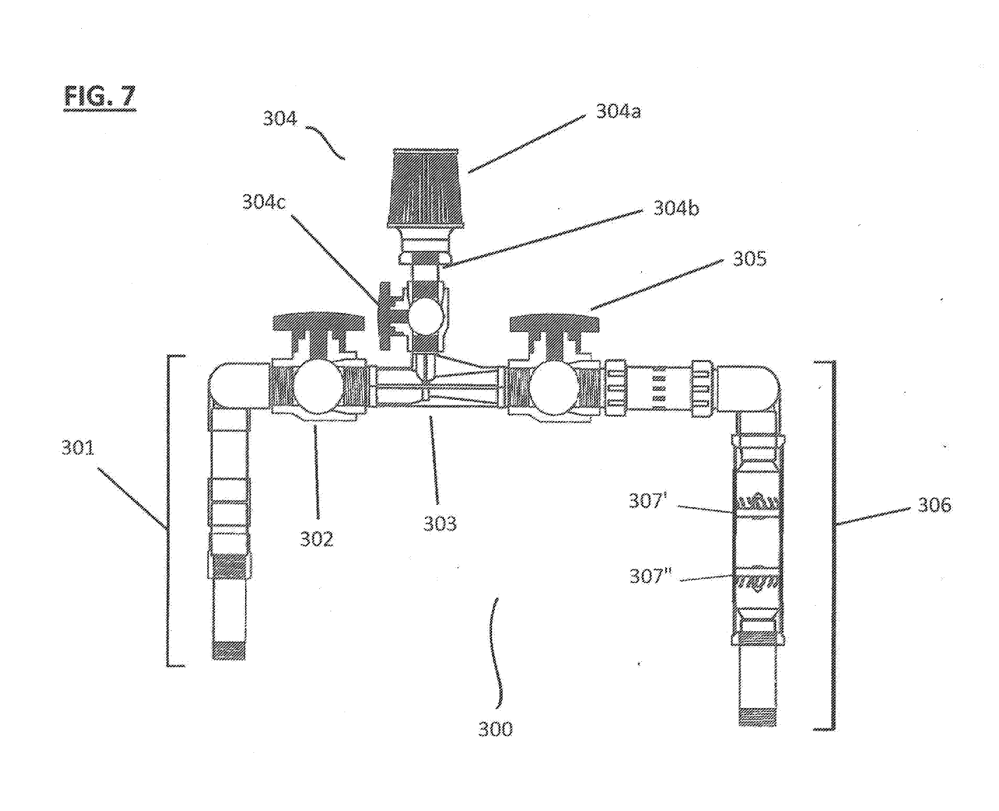

Without limiting the invention, FIG. 1 shows an exemplary cavitating apparatus 100 according to an embodiment of the present invention. The cavitating apparatus includes a delivery conduit 101, a fluid-gas mixing chamber 103 that connects with both a gas delivery system 104 and an exit conduit 106, and an inline cavitating turbine 107 downstream of the fluid-gas mixing chamber 103 and the gas delivery system 104. The cavitating system of FIG. 1 may be incorporated into a subterranean irrigation system such as those shown in FIGS. 6-7 (e.g., the cavitating system may be incorporated as an above-ground component of the irrigation system), or other systems that may benefit from the incorporation of micro-gas bubbles into a liquid.

The delivery conduit 101 may be constructed of pipe of various diameters and materials, which may be determined by the particular application of the system. For example, applications requiring a greater volume of water (e.g., large irrigation fields) the delivery conduit may have a larger diameter. The delivery conduit may include a pressure gauge to allow the user to monitor the pressure of the liquid passing into the fluid-gas mixing chamber 103. The cavitating apparatus 100 may include a valve between the delivery conduit 101 and the fluid-gas mixing chamber 103 that allows the user to control the liquid supply through the cavitating apparatus 100.

Water is supplied to the delivery conduit 101 by a main supply pipe, which may deliver liquid to multiple irrigation systems and multiple cavitating apparatuses. The flow and pressure of liquid from the main supply pipe to the delivery pipe may be controlled, in part, by a main valve positioned between the main supply pipe and the delivery conduit 101. The main valve may be a manually operated valve, having a manual valve actuator located above ground so that it may be accessed by the operator of the cavitating apparatus. In other implementations, and without limitation, the main valve may be remotely operable, e.g., it may be an electrically actuated valve under the control of analog electrical switches or a remote processor.

Once liquid passes from the main supply pipe into the cavitating apparatus 100 through the delivery conduit 101, it may pass into the gas-liquid mixing chamber 103. The gas-liquid mixing chamber 103 provides the point at which the gas from the gas delivery system 104 is drawn into the liquid flowing through the cavitating apparatus 100. The gas-liquid mixing chamber 103 may be in fluid connection with a gas delivery conduit 104b, which delivers gas supplied from a gas source by a device 104a (which may be a pump or other delivery device). The gas source may be atmospheric air, or other gases (e.g., CO₂, N₂, etc.) provided from source, such as a pressurized tank, etc. The gas-liquid mixing chamber 103 may have internal features for creating turbulence to aid in mixing the gas and the liquid combined in the gas-liquid mixing chamber 103, such as protrusions from the interior walls of the mixing chamber 103 (e.g., protrusions in a spiral pattern within the chamber, wedges or plates that have surfaces that are oblique or orthogonal to the direction of liquid flow in the mixing chamber, etc.), a perforated funnel or tube structure that protrudes from the gas delivery conduit 104a into the interior of the mixing chamber, which allows the gas to pass through the funnel or tube and provides a partial obstruction to create turbulence in the flowing liquid, a Venturi tube, or other physical structures within the mixing chamber that partially obstruct and/or redirect liquid flow in the mixing chamber to increase turbulence therein. The liquid that flows out of the gas-liquid mixing chamber 103 and into the exit conduit 106 contains significant volumes of air in bubbles of varying sizes, most of which are too large to be stable and retained in the liquid.

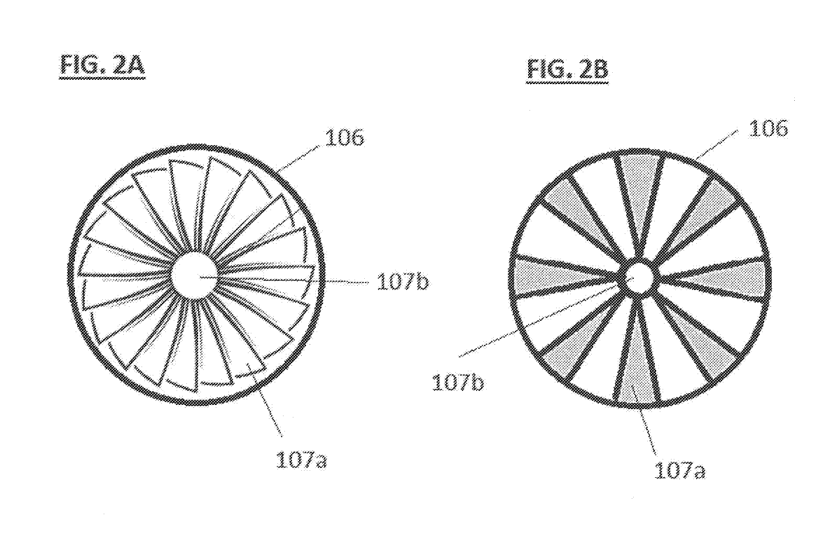

The gas-liquid mixture flowing from the gas-liquid mixing chamber 103 feeds into the exit conduit 106, in which an inline cavitating turbine 107 is positioned and through which the liquid-gas mixture flows. FIGS. 2A-2B provide cross-sectional views of an exit conduit having exemplary cavitating turbines positioned therein. The cavitating turbine 107 may include a freely spinning turbine blades 107a, such as a gas turbine blade design, Francis turbine blade design, a Kaplan turbine blade design, etc. The blades 107a may be connected to a central spinning axle 107b. As the liquid-gas mixture flows through the cavitating turbine the dynamic pressure of the liquid may drive the rotation of the turbine blade which, in turn generates microbubbles within the liquid-gas mixture as it chops through the liquid-gas mixture. The microbubbles may be generated by the breakup of existing gas bubbles by shearing forces created by the spinning blade, and/or by the creation of microbubbles resulting from a drop in the static pressure of the liquid passing through the conduit to a point that dissolved gases degas to form microbubbles in the liquid. The microbubbles generated by the cavitating turbine 107 may have diameters in a range of about 80 nm to about 10 μm. Microbubbles in this size range may stay distributed in solution, resisting coalescences and degassing, for sufficient time to delivery liquid with sufficient levels of dissolved gas(es) several tens to hundreds of yards.

After passing through the exit conduit 106 and the cavitating turbine therein, the liquid containing the microbubbles may feed the liquid-gas mixture into a conduit system (e.g., a subterranean irrigation system) to which the cavitating apparatus 100 is connected to provide the liquid-microbubble mixture for the desired application.

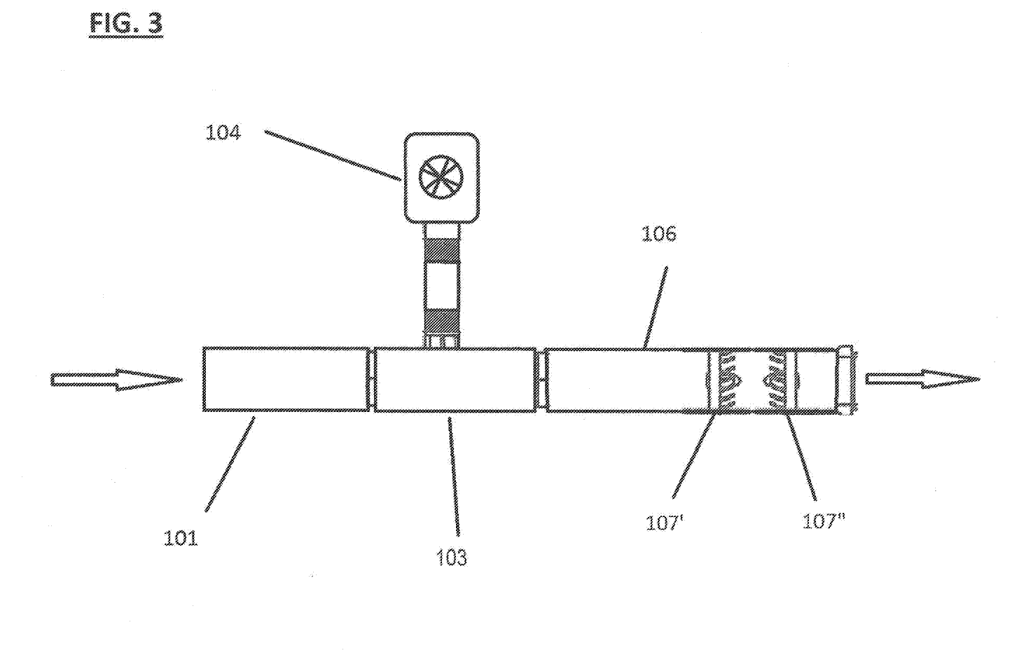

FIG. 3 shows a cavitating apparatus 100a according to an embodiment of the present invention. The cavitating apparatus 100a is similar to cavitating apparatus 100, and includes similar features including a delivery conduit 101, a fluid-gas mixing chamber 103 that connects with both a gas delivery system 104 and an exit conduit 106, and an inline cavitating turbine 107 downstream of the fluid-gas mixing chamber 103 and the gas delivery system 104. The details of the common features of cavitating apparatuses 100 and 100a are the same or similar and will not be described again to avoid redundancy. Like the cavitating apparatus 100, cavitating apparatus 100a may be incorporated into a subterranean irrigation system such as those shown in FIGS. 6-7 (e.g., the cavitating system may be incorporated as an above-ground component of the irrigation system), or other systems that may benefit from the incorporation of micro-gas bubbles into a liquid.

The major difference between cavitating apparatuses 100 and 100a is the present of a second cavitating turbine in the cavitating apparatus 100a. Rather than a single freely rotating turbine, the cavitating apparatus 100a includes a first cavitating turbine 107′ and a second cavitating turbine 107″. The blades of the first and second cavitating turbines may be configured such that the first and second cavitating turbines rotate in opposite directions as the liquid flows past (e.g., the first cavitating turbine spins clockwise, and the second cavitating turbine spins counterclockwise). However, it is to be understood that in some embodiments, the blades may rotate in the same rotational direction. The additional cavitating turbine causes further breakup of existing gas bubbles by shearing forces and/or an additional drop in the static pressure of the liquid passing through the conduit thereby more thoroughly breaking down the larger gas bubbles in the liquid column into microbubbles in the liquid and improving the dissolution of the gas in the liquid.

It is to be understood that the cavitating apparatus may include further cavitating turbines downstream (e.g., the cavitating system may include 3, 4, or more cavitating turbines), which aid in maintaining the gas dissolved and suspended in solution by repeatedly breaking down any gas bubbles in solution and counteracting any coalescence that may occur. Additionally, the fluid delivery system into which the gas-liquid mixture feeds (e.g., a subterranean irrigation system) may also include cavitating turbines placed at intervals therein.

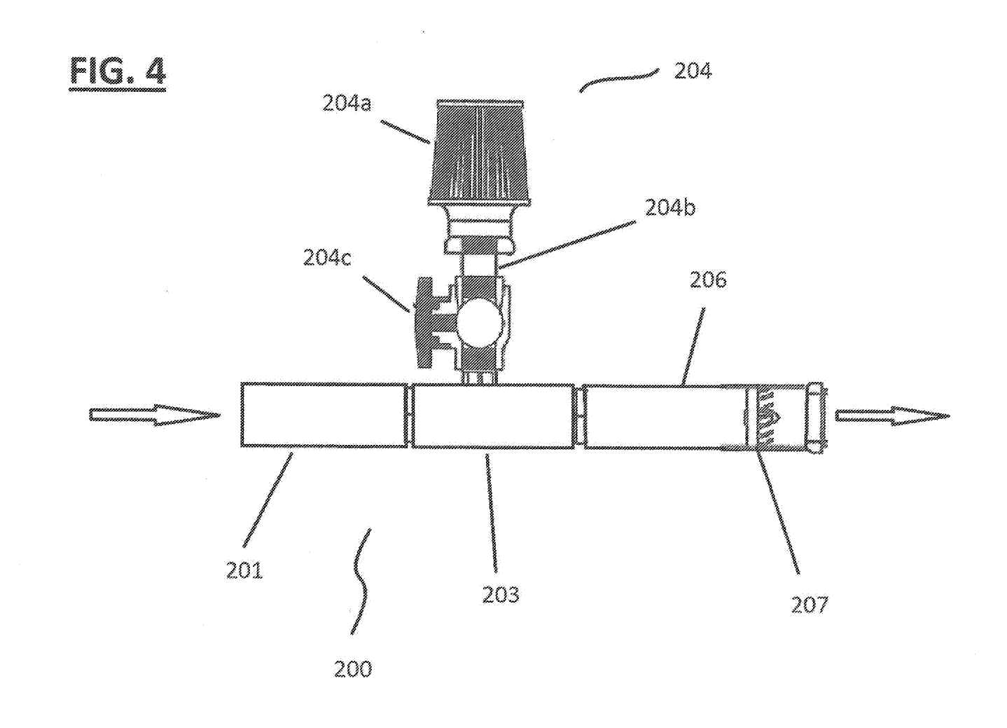

FIG. 4 shows a cavitating apparatus 200 according to an embodiment of the present invention. The cavitating apparatus 200 is similar to cavitating apparatus 100, and includes similar features including a delivery conduit 201 (similar to delivery conduit 101), a fluid-gas mixing chamber 203 (similar to fluid-gas mixing chamber 103) that connects with both a gas delivery system 204, and an exit conduit 206, and an inline cavitating turbine 207 downstream of the fluid-gas mixing chamber 203. The details of the common features of cavitating apparatuses 100 and 200 are the same or similar and will not be described again to avoid redundancy. Like the cavitating apparatus 100, cavitating apparatus 200 may be incorporated into a subterranean irrigation system such as those shown in FIGS. 6-7 (e.g., the cavitating system may be incorporated as an above-ground component of the irrigation system), or other systems that may benefit from the incorporation of micro-gas bubbles into a liquid.

The cavitating apparatus 200 shown in FIG. 4 includes an air delivery system 204 that may include several components, including an air filter 204a through which atmospheric air may be drawn into the air delivery conduit 204b. The air may be drawn through the air filter 204a by differential pressure between air in the conduit 204b and the atmospheric pressure. The pressure differential may develop as air in the conduit 204a is drawn into the liquid passing through the gas-liquid mixing chamber 203, creating a partial vacuum in the conduit 204b. It is to be understood that in other embodiments of the invention, air or other gases may be supplied from other sources into the cavitating apparatus, such as pressurized tanks, pumps, etc. In still other embodiments, and without limitation, a pump may be installed in the air delivery system to draw air through the air filter 204a at adjustable speeds to allow the user to designate various amounts of air to be infused into the liquid flowing through the cavitating apparatus.

In the exemplary cavitating apparatus 200 and in other related embodiments, and without limitation, the air filter 204a may be positioned above ground, such that atmospheric air may be drawn through it into the cavitating apparatus. In other embodiments, the gas delivery system may include a filter in other arrangements, such as between the gas delivery conduit and a pressurized tank or pump intake line. The air filter 204a may be serve to prevent particulate material and debris (e.g., dust, pollen, leaves, etc.) from being drawn into the cavitating apparatus, such that the risk and incidence of clogging in the cavitating apparatus and/or the conduit system to which the cavitating apparatus is connected is reduced.

The gas delivery system 204 may also include a gas delivery valve 204c for controlling the flow of gas through the gas delivery system 204. The valve 204c may be a ball valve. Other fluid valves may be alternatively used, such as a gate valve, a globe valve, a knife valve, and other appropriate fluid valves. The gas delivery valve may be used to cut off the supply of gas to the cavitating apparatus and, in some implementations, to adjust the rate of gas flow into gas-liquid mixing chamber 103 for modulating gas delivery to a conduit system to which the cavitating apparatus is connected.

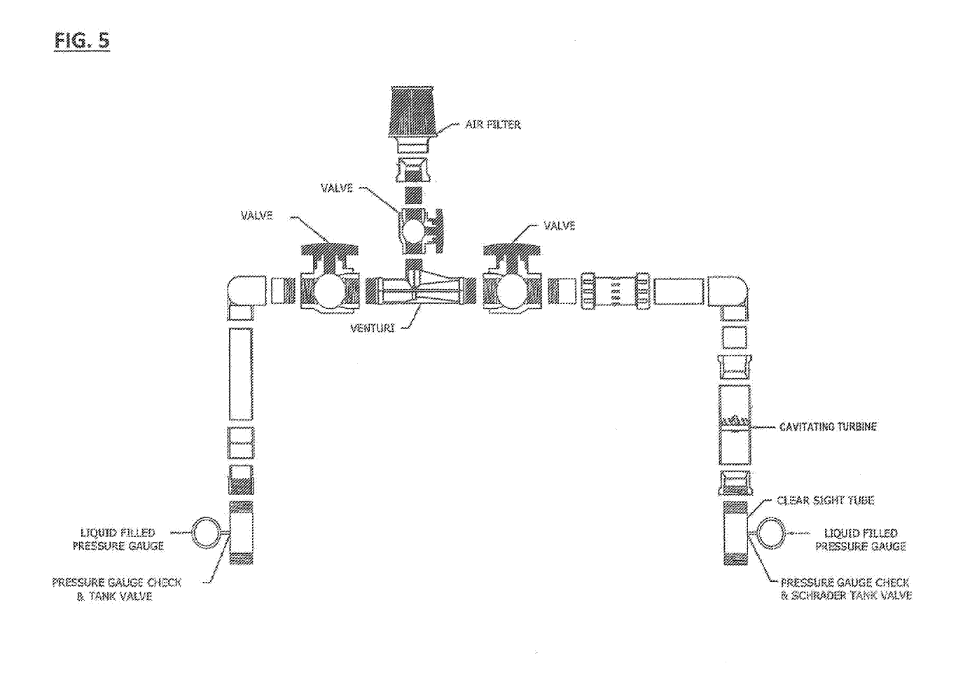

Without limiting the invention, FIGS. 5-6 show an exemplary cavitating apparatus 300 according to an embodiment of the present invention. FIG. 5 provided an exploding view of the cavitating apparatus 300 with the individual components shown separately. The cavitating apparatus includes a delivery conduit 301, a first valve 302, a Venturi tube 303 that connects with both an air delivery system 304 and second valve 305, an exit conduit 306, and an inline cavitating turbine 307 downstream of the Venturi tube 303 and the air delivery system 304.

The delivery conduit 301 may be constructed of pipe of various diameters and materials, which may be determined by the particular application of the system. For example, applications requiring a greater volume of water (e.g., large irrigation fields) the delivery conduit may have a larger diameter. The delivery conduit may include a pressure gauge to allow the user to monitor the pressure of the liquid passing into the Venturi tube 303. Also, the first valve 302 between the delivery conduit 301 and the Venturi tube 303 allows the user to cutoff the liquid supply through the cavitating apparatus.

Water is supplied to the delivery conduit 301 by a main supply pipe 310, which may deliver liquid to multiple irrigation systems and multiple cavitating apparatuses. The flow and pressure of liquid from the main supply pipe 310 to the delivery pipe may be controlled, in part, by a hydraulic valve 311. Hydraulic valve 311 controls the volume and pressure of liquid flowing from the main supply pipe through the main branching conduit 312 into a submain conduit 313. Thus, the pressure of the liquid delivered into the cavitating apparatus is controlled in the first instance by the hydraulic valve 311. The hydraulic valve 311 may be a manually operated valve, having a manual valve actuator located above ground so that it may be accessed by the operator of the cavitating apparatus. In other implementations, and without limitation, the hydraulic valve 313 may be remotely operable, e.g., it may be an electrically actuated valve under the control of analog electrical switches or a remote processor.

The submain conduit 313 receives delivers liquids from the main supply pipe 310 through the main branching conduit 312 and the cavitating apparatus 300. The cavitated liquid from the cavitating apparatus is mixed with the liquid directly from the main supply pipe 310 in the submain conduit, and it is then supplied into the individual delivery conduits (e.g., irrigation lines).

Once liquid passes from the main supply pipe 310 into the cavitating apparatus 304 through the delivery conduit 301, it may pass into the Venturi tube 303 (assuming valve 302 is open). The Venturi tube 303 provides the point at which the air from the air delivery system 304 is drawn into the liquid flowing through the cavitating apparatus 300. The Venturi tube 303 has a narrowing diameter that chokes the liquid flow and creates a lower dynamic pressure of the liquid at the choke point. The air delivery system 304 connects to the Venturi tube 303 at the choke point through an air injection port, thereby allowing the lowered dynamic pressure of the liquid to draw the air into the liquid from the air delivery system 304. The liquid that flows beyond the choke point include significant volumes of air in bubbles of varying sizes, most of which are too large to be stable and retained in the liquid.

The air delivery system 304 may include several components, including an air filter 104a through which atmospheric air may be drawn into the air delivery conduit 304b. The air may be drawn through the air filter 304a by differential pressure between air in the conduit 304b and the atmospheric pressure. The pressure differential may develop as air in the conduit 304a is drawn into the liquid passing through the Venturi tube 303, creating a partial vacuum in the conduit 304b. It is to be understood that in other embodiments of the invention, air or other gases may be supplied from other sources into the cavitating apparatus, such as pressurized tanks, pumps, etc. In still other embodiments, and without limitation, a pump may be installed in the air delivery system to draw air through the air filter 304a at adjustable speeds to allow the user to designate various amounts of air to be infused into the liquid flowing through the cavitating apparatus.

In the exemplary cavitating apparatus 300 and in other related embodiments, and without limitation, the air filter 304a may be positioned above ground, such that atmospheric air may be drawn through it into the cavitating apparatus. In other embodiments, the gas delivery system may include a filter in other arrangements, such as between the gas delivery conduit and a pressurized tank or pump intake line. The air filter 304a may be serve to prevent particulate material and debris (e.g., dust, pollen, leaves, etc.) from being drawn into the cavitating apparatus, such that the risk and incidence of clogging in the cavitating apparatus and/or the conduit system to which the cavitating apparatus is connected is reduced.

The gas delivery system 304 may also include a gas delivery valve 304c for controlling the flow of gas through the gas delivery system 304. The valve may be a ball valve 104c, as shown in FIGS. 5-6. Other fluid valves may be alternatively used, such as a gate valve, a globe valve, a knife valve, and other appropriate fluid valves. The gas delivery valve may be used to cut off the supply of gas to the cavitating apparatus and, in some implementations, to adjust the rate of gas flow into the Venturi tube for modulating gas delivery to a conduit system to which the cavitating apparatus is connected.

The Venturi tube 303 feeds the liquid-gas mixture into an exit conduit 306, which feeds the liquid-gas mixture into the conduit system (e.g., a subterranean irrigation system) to which the cavitating apparatus 300 is connected. The exit conduit 306 has an inline cavitating turbine 307 therein through which the liquid-gas mixture flows.

The exit conduit 306 may also include a second valve 305 that may be used to controlling the flow of the liquid-gas mixture through the exit conduit. The valve 305 may be a ball valve. Other fluid valves may be alternatively used, such as a gate valve, a globe valve, a knife valve, and other appropriate fluid valves. The exit conduit valve may be used to cut off the supply of the liquid-gas mixture through the exit conduit and, in some implementations, to adjust the flow rate of the liquid-gas mixture into a conduit system (e.g., a subterranean irrigation system) to which the exit conduit is connected.

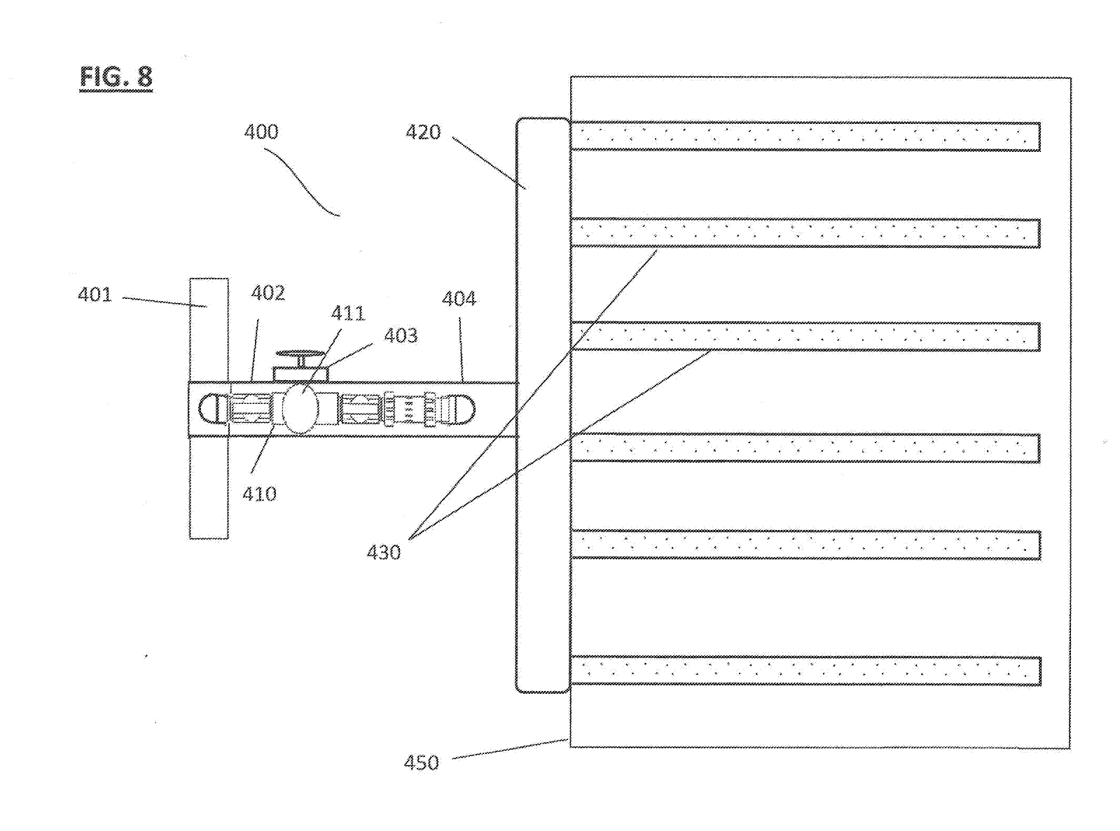

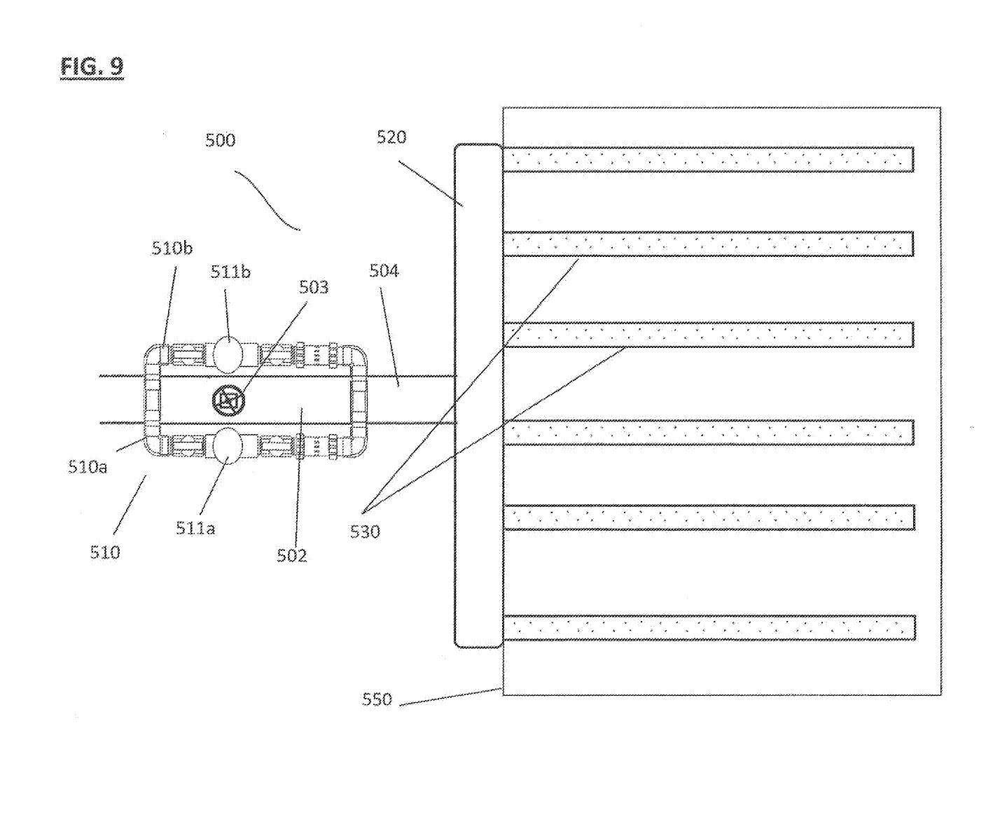

FIG. 7 shows a cavitating apparatus 300a according to an embodiment of the present invention. The cavitating apparatus 300a is similar to cavitating apparatus 300, and includes similar features including a delivery conduit 301, a fluid-gas mixing chamber 303 that connects with both a gas delivery system 304 and an exit conduit 306, and a cavitating turbine downstream of the fluid-gas mixing chamber 303 and the gas delivery system 304. The details of the common features of cavitating apparatuses 300 and 300a are the same or similar and will not be described again to avoid redundancy. Like the cavitating apparatus 300, cavitating apparatus 300a may be incorporated into a subterranean irrigation system such as those shown in FIGS. 8-9 (e.g., the cavitating system may be incorporated as an above-ground component of the irrigation system), or other systems that may benefit from the incorporation of micro-gas bubbles into a liquid.

The major difference between cavitating apparatuses 300 and 300a is the present of a second cavitating turbine in the cavitating apparatus 300a. Rather than a single freely rotating turbine, the cavitating apparatus 300a includes a first cavitating turbine 307′ and a second cavitating turbine 307″. The blades of the first and second cavitating turbines may be configured such that the first and second cavitating turbines rotate in opposite directions as the liquid flows past (e.g., the first cavitating turbine spins clockwise, and the second cavitating turbine spins counterclockwise). However, it is to be understood that in some embodiments, the blades may rotate in the same rotational direction. The additional cavitating turbine causes further breakup of existing gas bubbles by shearing forces and/or an additional drop in the static pressure of the liquid passing through the conduit thereby more thoroughly breaking down the larger gas bubbles in the liquid column into microbubbles in the liquid and improving the dissolution of the gas in the liquid.

It is to be understood that the cavitating apparatus may include further cavitating turbines downstream (e.g., the cavitating system may include 3, 4, or more cavitating turbines), which aid in maintaining the gas dissolved and suspended in solution by repeatedly breaking down any gas bubbles in solution and counteracting any coalescence that may occur. Additionally, the fluid delivery system into which the gas-liquid mixture feeds (e.g., a subterranean irrigation system) may also include cavitating turbines placed at intervals therein.

FIG. 8 provides an overhead view of an exemplary subterranean irrigation system 400, which includes a cavitating apparatus 410 according to an embodiment of the cavitating apparatuses described herein. The irrigation system 400 may be operable to serve a particular division of a growing operation, e.g., a plot 450 having a size in a range of about 1 to about 10 acres. The irrigation system 400 may include a main water delivery line 401 that delivers irrigation water to the plot 450. The main water delivery line 401 may branch and deliver water to a main branching conduit 402 that feeds water to a cavitating apparatus and a submain conduit 204 and the irrigation lines in the plot 450. The flow and pressure of water from the main water delivery line 201 may be controlled by a hydraulic valve 403.

The cavitating apparatus 410 may be connected to the main branch conduit 402 at its proximal end and the submain conduit 404 at its distal end. The cavitating apparatus 410 may branch off vertically such that it breaches the surface of the soil. The air delivery system 411 of the cavitating apparatus is positioned above ground allowing it to draw air through a filter into the cavitating apparatus. The air is mixed with the water siphoned from the flow of irrigation water from the main water delivery line 401 into the main branching conduit 402. The water-air mixture is then passed through an inline cavitating turbine positioned within the cavitating apparatus to generate air microbubbles, as described above. It is to be understood that the cavitating apparatus 410 may include a plurality of cavitating turbines therein (e.g., the cavitating system may include 3, 4, or more cavitating turbines). The plurality of cavitating turbines may be configured such that at least one spins in a clockwise direction and at least one of the plurality of cavitating turbine spins in the opposite direction, as discussed herein. It is to be further understood that the subterranean irrigation system 400 into which the gas-liquid mixture feeds may also include cavitating turbines placed at intervals therein.

The water-air mixture may then flow into the submain conduit 404 downstream of the cavitating apparatus 410 and then flow into a manifold 420 of subterranean irrigation conduits over which crop rows are positioned (e.g., bell peppers, strawberries, etc.). The gas-infused irrigation water is discharged along the length of the irrigation conduits 430 through perforations or gaps in the conduit. The size of the microbubbles generated by the cavitating apparatus are sufficiently small to allow the microbubbles to persist in the irrigation water to the end of the irrigation conduits so that plant roots located at the end of the irrigation conduits receive adequate oxygen and/or other gases, which may be several tens to hundreds of yards in length (e.g., up to about 500 yards in length).

FIG. 9 provides an overhead view of an exemplary subterranean irrigation system 500, which includes an above-ground cavitating apparatus 510. The irrigation system 500 may be operable to serve a particular division of a growing operation, e.g., a plot 550 having a size in a range of about 1 to about 10 acres. The irrigation system 500 may include a main water delivery line 501 that delivers irrigation water to the plot 550. The main water delivery line 501 may branch and deliver water to a main branching conduit 502 that feeds water to a cavitating apparatus and a submain conduit 504 and the irrigation lines in the plot 550. The flow and pressure of water from the main water delivery line 401 may be controlled by a hydraulic valve 503.

The cavitating apparatus 510 may be connected to the main branch conduit 502 at its proximal end and the submain conduit 504 at its distal end. The cavitating apparatus 510 may branch off vertically such that it breaches the surface of the soil. The cavitating apparatus includes two air infusion lines 510a and 510b (it is to be understood that the scope of the invention includes cavitating apparatuses that have more than one or two air infusion lines, e.g., 3, 4, etc.). Each air infusion line 510a and 510b draws water from the main branch conduit 502 through a vertical delivery pipe (obscured by the cavitating apparatus 510 in FIG. 9). Each air infusion line includes a gas-liquid mixing chamber (e.g., a Venturi tube, etc.) attached to an air delivery system (511a and 511b). The air delivery systems 511a and 511b of the cavitating apparatus are positioned above ground allowing them to draw air through a filter into the cavitating apparatus 510 to be mixed with the water flowing through the air infusion lines 510a and 510b, respectively. The air is mixed with the water siphoned from the flow of irrigation water in the main branch conduit 502 into the cavitating apparatus 510. The water-air mixture is then passed through an inline cavitating turbine positioned within the cavitating apparatus to generate air microbubbles, as described above. The cavitating turbine may be positioned in a water return pipe (obscured by the cavitating apparatus 510 in FIG. 9), which connects the distal ends of both of the air infusion lines 510a and 510b to the main water delivery line 501. It is to be understood that the cavitating apparatus 510 may include a plurality of cavitating turbines therein (e.g., the cavitating system may include 3, 4, or more cavitating turbines). The plurality of cavitating turbines may be configured such that at least one spins in a clockwise direction and at least one of the plurality of cavitating turbine spins in the opposite direction, as discussed herein. It is to be further understood that the subterranean irrigation system 500 into which the gas-liquid mixture feeds may also include cavitating turbines placed at intervals therein.

The water-air mixture generated by the cavitating system 510 may flow into the submain conduit 504 downstream of the cavitating apparatus 510 and then flow into a manifold 520 of subterranean irrigation conduits over which crop rows are positioned (e.g., bell peppers, strawberries, etc.). The gas-infused irrigation water is discharged along the length of the irrigation conduits 530 through perforations or gaps in the conduit. The size of the microbubbles generated by the cavitating apparatus are sufficiently small to allow the microbubbles to persist in the irrigation water to the end of the irrigation conduits so that plant roots located at the end of the irrigation conduits receive adequate oxygen and/or other gases, which may be several tens to hundreds of yards in length (e.g., up to about 500 yards in length).

The present invention provides a cavitating apparatus for use in various liquid delivery systems (including irrigation systems) that includes an inline cavitating turbine for generating fine microbubbles, as well as systems and methods that utilize such cavitating apparatuses. It should also be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A cavitating apparatus, comprising:
a. a liquid delivery conduit for receiving liquid;
b. a gas-liquid mixing chamber connected to a distal end of said liquid delivery conduit, wherein said gas-liquid mixing chamber includes a gas injection port;
c. a gas delivery system connected to said gas injection port;
d. a liquid exit conduit for collecting a gas-liquid mixture from a distal end of said gas-liquid mixing chamber; and
e. at least one inline cavitating turbine in said liquid exit conduit.

2. The apparatus of claim 1, wherein said cavitating turbine is free-spinning and the force of the liquid flowing through liquid exit conduit is sufficient to spin said cavitating turbine.

3. The apparatus of claim 2, wherein said cavitating turbine forms microbubbles as it spins.

4. The apparatus of claim 3, wherein said microbubbles have a diameter in a range of about 80 nm to about 1 μm.

5. The apparatus of claim 1, wherein said gas delivery system includes a filter through which said gas is drawn into a gas delivery conduit and into said gas injection port.

6. The apparatus of claim 1, wherein said gas delivery system includes a pump that introduces gas from a gas source into said gas injection port.

7. The apparatus of claim 1, wherein said gas-liquid mixing chamber is a Venturi tube that chokes the diameter of the cavitating apparatus to reduce a pressure of the liquid flowing through the Venturi tube to draw said gas into the liquid to generate said gas-liquid mixture.

8. The apparatus of claim 1, wherein said gas-liquid mixing chamber comprises interior protrusions for creating turbulence in the liquid flowing through the gas-liquid chamber.

9. The apparatus of claim 1, wherein said cavitating apparatus comprise a plurality of inline cavitating turbines in said liquid exit conduit.

10. The apparatus of claim 9, wherein a first cavitating turbine of said plurality of inline cavitating turbines spins in a first rotational direction and a second cavitating turbine of said plurality of inline cavitating turbines spins in a second rotational direction that is opposite to the first rotational direction.

11. The apparatus of claim 1, wherein said liquid exit conduit connects with a liquid delivery system at its distal end and delivers said liquid-gas mixture into said liquid delivery system.

12. An irrigation system, comprising:
a. a main water delivery conduit for supplying water to an irrigation plot;
b. a cavitating system including
i. a siphoning conduit for drawing a portion of said water from said main water delivery conduit,
ii. a gas-liquid mixing chamber connected to a distal end of said siphoning conduit, wherein said gas-water mixing chamber includes a gas injection port,
iii. a gas delivery system connected to said gas injection port,
iv. a cavitated water delivery conduit for collecting a gas-water mixture from a distal end of said gas-water mixing chamber and delivering cavitated water back to said main water delivery conduit, and
v. an inline cavitating turbine in said cavitated water delivery conduit for cavitating said gas-water mixture; and
c. a plurality of irrigation lines for receiving water from said main water delivery conduit downstream from said cavitated water delivery conduit.

13. The system of claim 12, wherein said cavitating turbine is free-spinning and the force of the liquid flowing through liquid exit conduit is sufficient to spin said cavitating turbine.

14. The system of claim 14, wherein said cavitating turbine forms microbubbles as it spins.

15. The system of claim 14, wherein said microbubbles have a diameter in a range of about 80 nm to about 1 μm.

16. (canceled)

17. The system of claim 12, wherein said gas delivery system includes a pump that introduces gas from a gas source into said gas injection port.

18. The system of claim 12, wherein said gas-water mixing chamber is a Venturi tube that chokes the diameter of the cavitating apparatus to reduce a pressure of the water flowing through the Venturi tube to draw said air into the liquid to generate said gas-water mixture.

19. The system of claim 12, wherein said gas-water mixing chamber comprises interior protrusions for creating turbulence in the liquid flowing through the gas-water mixing chamber.

20. The system of claim 12, wherein said cavitating apparatus comprise a plurality of inline cavitating turbines in said liquid exit conduit.

21. (canceled)

22. The system of claim 12, wherein said cavitated water delivery conduit connects with said main water delivery conduit at its distal end and delivers said cavitated water into said main water delivery conduit, such that the cavitated water and said water remaining in said main water delivery conduit mix.

23. The system of claim 12, said irrigation system is subterranean, and the gas delivery system is above ground.

24. (canceled)

25. (canceled)

26. (canceled)

27. A method of creating a cavitated liquid comprising, comprising:
a. drawing a liquid from a liquid source into a proximal conduit;
b. passing said liquid through a gas-liquid mixing chamber to generate a liquid-gas mixture, wherein said gas-liquid mixing chamber includes a gas injection port connected to a gas delivery system;
c. collecting the gas-liquid mixture in a distal conduit; and
d. passing said gas-liquid mixture through at least one cavitating turbine located within the lumen of said distal conduit.

28. The method of claim 18, wherein said cavitating turbine is free-spinning, such that the force of said gas-liquid mixture drives the rotation of said at least one cavitating turbine.

29. The method of claim 28, wherein said at least one cavitating turbine forms microbubbles as it spins in the flowing gas-liquid mixture.

30. (canceled)

31. (canceled)

32. (canceled)

33. (canceled)

34. (canceled)

35. The method of claim 27, wherein said cavitating apparatus comprise a plurality of inline cavitating turbines in said liquid exit conduit.

36. The method of claim 35, wherein a first cavitating turbine of said plurality of inline cavitating turbines spins in a first rotational direction and a second cavitating turbine of said plurality of inline cavitating turbines spins in a second rotational direction that is opposite to the first rotational direction.

37-61. (canceled)
